(19) United States
(12) Patent Application Publication
(10) Pub. No.: US 2004/0196745 A1
(43) Pub. Date: Oct. 7, 2004

(54) Magneto-optical recording medium and method for producing magneto-optical recording medium

(75) Inventors: Hiroshi Ido, Moriya-shi (JP); Hiroyuki Awano, Noda-shi (JP); Manabu Tani, Moriya-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 10/809,429

(22) Filed: Mar. 26, 2004

(30) Foreign Application Priority Data
Apr. 1, 2003 (JP) 2003-097950

(51) Int. Cl. G11B 7/24; G11B 5/64

(52) U.S. Cl. 369/13.42; 369/288; 369/13.45; 369/13.47

(57) ABSTRACT

A magneto-optical recording medium wherein a magnetic domain is transferred from a recording layer to a reproducing layer is expanded. When the reproducing layer is formed, the composition ratio of a transition metal at a surface of the reproducing layer on a reproducing light beam-incoming side is made to be higher than the composition ratio of the transition metal at a surface of the reproducing layer on a side opposite to the reproducing light beam-incoming side. Thus, the operation to expand the magnetic domain, transferred from the recording layer to the reproducing layer, is performed smoothly, and the jitter of the reproduced signal is reduced to improve signal-to-noise ratio (S/N) of the reproduced signal.

### BACKGROUND OF THE INVENTION

1. Field of the Invention

The present invention relates to a magneto-optical recording medium and a method for producing the same. In particular, the present invention relates to a magneto-optical recording medium capable of reproducing information having been recorded at a high density, reliably at a sufficient reproduced signal intensity, and a method for producing the same.

2. Description of the Related Art

An optical recording medium, which is generally used at present, comprises, for example, a substrate made of polycarbonate, a magnetic thin film formed on or applied to the substrate, and a phase-change thin film or a dye thin film. A groove (track) is previously engraved in a spiral form on the substrate. A laser beam is radiated onto the thin film on the groove while performing the scanning across the laser beam along the groove to record and reproduce information. On the conventional optical recording medium as described above, information is recorded and reproduced by allowing the recording/reproducing laser beam to come into the medium from the side of the substrate. Therefore, it is hardly possible that data cannot be reproduced, for example, due to any scratch or dust on the substrate. Therefore, the optical recording medium, which is of such a type that information is recorded/reproduced by allowing the recording/reproducing laser beam to come from the side of the substrate, is useful as a recording medium which can be freely carried to a desired place. An optical recording medium of another type has been also contrived, in which the recording medium is protected from the scratch and the dust by using a cartridge or the like, and information is recorded/reproduced by radiating the laser beam directly onto the recording surface without allowing the laser beam to pass through the substrate. In the case of the optical recording medium of such a type, the spot diameter of the laser beam collected on the recording medium can be further decreased by using an objective lens having a large numerical aperture. Therefore, such an optical recording medium is advantageous to be used as a medium of high recording density.

The high density recording of information is achieved by narrowing the spacing distance between tracks (hereinafter referred to as “track pitch”) and narrowing the spacing distance between recording marks (hereinafter referred to as “bit pitch”) so that the size of the recording mark is decreased. However, if the recording mark is made to be smaller than the spot diameter of the reproducing light beam, a problem arises such that a plurality of recording marks are included in the spot and it is impossible to distinguish the recording marks. This problem is not limited to the optical recording medium, which also arises in the case of the magneto-optical recording medium.

In relation to the magneto-optical recording medium, those having been suggested as the method for solving this problem include two reproducing methods, i.e., the magnetic super resolution system (see, for example, Japanese Patent Application Laid-open No. 6-150418, pp. 7-8, FIGS. 1 to 6) and the magnetic amplifying magneto-optical system (see, for example, Japanese Patent Application Laid-open No. 8-7350, pp. 2-3, FIGS. 1, 5, and 6). The magneto-optical recording medium, which is based on the magnetic super resolution system, principally comprises a recording layer in which recording magnetic domains corresponding to information are recorded, and a magnetic layer which is provided to assist reproduction of the recording magnetic domains. In the case of the magnetic super resolution system, the reproduction of information, which effectively exceeds the resolution of the reproducing light beam, can be performed by combining the magnetic characteristic of the magnetic super resolution medium with the temperature distribution in the spot of the reproducing light beam radiated onto the magneto-optical recording medium upon the reproduction of information. However, in the case of the magneto-optical recording medium based on the magnetic super resolution system, the spot size of the reproducing light beam, which contributes to the reproduction, is decreased. Therefore, the amplitude of the reproduced signal is decreased as well.

On the other hand, the magneto-optical recording medium, which is based on the magnetic amplifying magneto-optical system (MAMMOS), principally comprises a recording layer in which information is recorded as magnetic domains, and a reproducing layer which performs reproduction while amplifying or expanding magnetic domains transferred from the recording layer. In the case of the magneto-optical recording medium based on the magnetic amplifying magneto-optical system, the magnetic domains of the recording layer are transferred to the reproducing layer by radiating the reproducing light beam onto the magneto-optical recording medium to effect the heating, and the magnetic domains, which have been transferred to the reproducing layer, are amplified or expanded by the aid of the reproducing magnetic field. Therefore, even when information is recorded as minute recording magnetic domains (recording marks) in the recording layer, the reproduced signal can be detected from the magnetic domains expanded in the reproducing layer during the reproduction. Thus, it is possible to reproduce information with a sufficient signal amplitude. Therefore, the magneto-optical recording medium based on the magnetic amplifying magneto-optical system is more effective as the high recording density medium than the magneto-optical recording medium based on the magnetic super resolution system.

On the other hand, the magneto-optical recording medium includes those of the type in which the reproducing light beam is allowed to come into the medium from the side of the substrate, and those of the type in which the reproducing light beam is directly radiated onto the recording film (see, for example, Japanese Patent Application Laid-open No. 2001-228032, p. 5). A magneto-optical recording medium, which is disclosed in Japanese Patent Application Laid-open No. 2001-228032, has a magnetic layer which comprises only one layer of an information-recording layer, in which the recording and reproduction characteristics are improved by adjusting the thickness and the composition of a reflective film.

As described above, the magnetic amplifying magneto-optical system makes it possible to perform the high density recording on the magneto-optical recording medium. Therefore, it is expected to realize a commercially available product of the magneto-optical recording medium suitable for this system. In particular, when a short wavelength laser such as a blue laser is used for the reproducing light beam, it is possible to perform the recording at higher densities. In order to respond to the expectation as described above, it is necessary to further optimize the magneto-optical recording medium based on the magnetic amplifying magneto-optical system. For this purpose, it is necessary to investigate the optimization, for example, for the magnetic characteristics of the magnetic layer.

### SUMMARY OF THE INVENTION

An object of the present invention is to provide a magneto-optical recording medium based on the magnetic amplifying magneto-optical system which is excellent in reproduction characteristics at a high recording density by contemplating the optimization of a magnetic layer for constructing the magneto-optical recording medium based on the magnetic amplifying magneto-optical system.

According to a first aspect of the present invention, there is provided a magneto-optical recording medium wherein a magnetic domain is expanded to reproduce information from the expanded magnetic domain by irradiating the magneto-optical recording medium with a reproducing light beam comprising a recording layer which is formed of a rare earth transition metal; a reproducing layer which is formed of a rare earth transition metal; and an auxiliary magnetic layer which is formed of a magnetic material and which is arranged between the recording layer and the reproducing layer, wherein a transition metal, which is contained in the rare earth transition metal at a surface of the reproducing layer on a reproducing light beam-incoming side, has a composition ratio which is higher than a composition ratio of a transition metal which is contained in the rare earth transition metal at a surface of the reproducing layer on a side opposite to the reproducing light beam-incoming side.

The magneto-optical recording medium according to the first aspect of the present invention is a magneto-optical recording medium based on the magnetic amplifying magneto-optical system in which no external magnetic field is required when information is reproduced (hereinafter referred to as “Zero-Field MAMMOS”). The magneto-optical recording medium principally comprises the recording layer in which information is recorded as magnetic domains, the reproducing layer which expands the magnetic domains transferred from the recording layer to perform the reproduction, and the auxiliary magnetic layer (hereinafter referred to as “trigger layer” as well) which is provided to control the magnetic exchange coupling force exerted between the recording layer and the reproducing layer. In this magneto-optical recording medium, the recording layer, the auxiliary magnetic layer, and the reproducing layer are subjected to magnetic exchange coupling in a state in which the magneto-optical recording medium is not irradiated with the reproducing light beam; the magnetic domain, which is transferred from the recording layer to the reproducing layer, is expanded to reproduce information from the expanded magnetic domain by irradiating the magneto-optical recording medium with the reproducing light beam to heat to a temperature not less than a temperature at which an exchange coupling force between the recording layer and the reproducing layer is cut off. An explanation will be briefly made below about the principle of reproduction of information on the magneto-optical recording medium based on the Zero-Field MAMMOS.

The recording layer is formed of a rare earth transition metal alloy composed of, for example, Tb, Fe, and Co. The recording layer is designed to exhibit the ferri-magnetization in which the transition metal is dominant (hereinafter referred to as “TM (Transition Metal)-rich”) from room temperature to the Curie temperature, for which the composition is selected so that the perpendicular magnetized film is formed. The Curie temperature and the coercive force of the recording layer are designed to be sufficiently large. Therefore, even when the reproducing light beam is radiated upon the reproduction of information, the magnetization of the recording magnetic domain, which corresponds to the information, is retained. The reproducing layer is formed of a rare earth transition metal alloy composed of, for example, Gd, Fe, and Co. The reproducing layer is designed to exhibit the ferri-magnetization in which the rare earth metal is dominant (hereinafter referred to as “RE (Rare Earth)-rich”) from room temperature to the Curie temperature, for which the composition is selected so that the perpendicular magnetized film is formed. The trigger layer is formed of a rare earth transition metal alloy composed of, for example, Tb and Fe. However, in the following description, it is assumed that the trigger layer is formed of a TM-rich rare earth transition metal, and the trigger layer is designed to possess the perpendicular magnetization at a temperature which is sufficiently lower than the Curie temperature. Further, the reproducing layer is designed so that the size of the minimum magnetic domain, i.e., the so-called minimum magnetic domain diameter, at which the magnetic domain is capable of existing stably, is larger than that of the recording layer. Usually, the minimum magnetic domain diameter of the reproducing layer is adjusted to be approximately the size of the spot diameter of the reproducing light beam.

An explanation will be made with reference to FIGS. 6 to 9 about the principle of magnetic domain expansion in the reproducing layer of the magneto-optical recording medium based on the Zero-Field MAMMOS. FIG. 6 shows magnetization states of magnetic domains formed in the recording layer 4, the trigger layer 5, and the reproducing layer 6 of the magneto-optical recording medium based on the Zero-Field MAMMOS before being irradiated with the reproducing light beam. It is assumed that all of the magnetic domains, which are formed in the respective layers, have an identical size in the disk traveling direction before being irradiated with the reproducing light beam as shown in FIG. 6. In FIG. 6, thick arrows (blanked arrows) indicate (synthetic or combined) magnetizations in the respective layers, and thin arrows (solid arrows), which are depicted in the thick arrows, indicate magnetic spins of the transition metal (Fe or Co). The recording layer 4 and the trigger layer 5 are TM-rich. Therefore, the overall magnetizations thereof are directed in the same directions as those of the spins of the transition metal in relation to the magnetic domains aligned in identical vertical columns. On the other hand, the reproducing layer 6 is RE-rich. Therefore, the overall magnetizations are directed in the directions opposite to those of the spins of the transition metal.

The respective transition metals of the recording layer 4, the trigger layer 5, and the reproducing layer 6 are coupled to one another by the strong coupling force of not less than several tens kOe at room temperature. Therefore, as shown in FIG. 6, all of the thin arrows, which indicate the magnetic spins of the transition metals, are directed in the same directions in relation to the magnetic domains disposed in the identical vertical columns of the recording layer 4, the trigger layer 5, and the reproducing layer 6. Therefore, the overall magnetizations of the magnetic domains in the reproducing layer 6 are directed in the directions opposite to those of the overall magnetizations of the magnetic domains of the trigger layer 5 and the recording layer 4 disposed thereunder. The magnetic domains of the recording layer 4 are transferred to the reproducing layer 6 in the opposite directions. It is now assumed that the respective magnetic domains in the trigger layer 5 and the reproducing layer 6 are conceptually regarded, for example, as magnets 5′, 6′ as indicated in a right portion of FIG. 6. On this assumption, the state, in which the overall magnetizations of the trigger layer 5 and the reproducing layer 6 are directed in the mutually opposite directions, is equivalent to the state in which the identical magnetic poles of the magnets 5′, 6′ are disposed adjacent to one another. This state is magnetostatically extremely unstable. That is, the unstable state is brought about due to the repulsive force of the magnetostatic energy exerted between the trigger layer 5 and the reproducing layer 6. However, the exchange coupling force, which is exerted by the spins of the transition metals of the trigger layer 5 and the reproducing layer 6, is stronger than the repulsive force of the magnetostatic energy before the reproducing light beam is radiated. Therefore, the state is continued as shown in FIG. 6, in which the overall magnetizations of the trigger layer 5 and the reproducing layer 6 are directed in the mutually opposite directions.

In order to reproduce information, as shown in FIG. 7, when the reproducing light beam 10 is collected by an objective lens 9 to irradiate the magneto-optical recording medium therewith so that a light spot S is formed on the reproducing layer 6, then a temperature distribution is generated in the light spot S in accordance with the light intensity distribution of the reproducing light beam 10, and the temperature is raised especially in the vicinity of the center of the light spot S. On this condition, the trigger layer 5 functions to cut off the magnetic coupling (exchange coupling) between the magnetic domains 15 of the recording layer 4 and the magnetic domains 13 of the reproducing layer 6 adjoining thereover and thereunder in the vertical direction in a heated area 11 of the trigger layer 5 (hereinafter referred to as “reproducing temperature area” as well). A method for cutting off the exchange coupling force is available. That is, for example, the exchange coupling force between the recording layer and the reproducing layer may be cut off by changing the magnetization of the trigger layer 5 in the reproducing temperature area 11 from the perpendicular magnetization to the in-plane magnetization. A consideration will be made about the magnetic domain 23 of the reproducing layer 6 adjacent to the magnetic domains 13 of the reproducing layer 6 disposed at the upper portion of the reproducing temperature area 11 and the magnetic domain 25 of the recording layer 4 disposed thereunder as shown in FIG. 7.

At first, as shown in FIG. 8A, it is assumed that the domain wall 26 of the magnetic domain 23 of the reproducing layer 6 is not moved to maintain the state as it is when the reproducing light beam 10 is radiated. On this assumption, FIG. 8B shows the relationship between the attracting force of the exchange energy (exchange coupling force) and the repulsive force of the magnetostatic energy exerted on the lower surface of the reproducing layer 6. However, the magneto-optical recording medium travels in the direction indicated by the arrow of broken line shown in FIG. 8A relative to the reproducing light beam 10. Therefore, the reproducing temperature area 11 of the trigger layer 5, in which the exchange coupling force to be exerted between the recording layer 4 and the reproducing layer 6 is cut off, is formed in the area deviated in the traveling direction of the magneto-optical recording medium (left side in FIG. 8A) in the light spot not in the central portion in the reproducing light spot S. As shown in FIG. 8A, the right portion in the reproducing light spot S is in a state in which the temperature is still low, and a large attracting force of the exchange energy and a large repulsive force of the magnetostatic energy are exerted on the reproducing layer 6.

The attracting force of the exchange energy is the attracting force which is generated on the basis of the exchange coupling energy brought about between the transition metal of the reproducing layer 6 and the transition metal of the trigger layer 5. A strong coupling force is mutually exhibited by the transition metals. Therefore, as shown in FIG. 8B, an extremely large value is exhibited in the low temperature area, which exceeds the repulsive force of the magnetostatic energy. However, as shown in FIG. 8B, in accordance with the approach to the reproducing temperature area from the low temperature area, the attracting force of the exchange energy is suddenly decreased, which becomes zero in the reproducing temperature area, for the following reason. That is, the trigger layer 5 serves in the reproducing temperature area to cut off the exchange coupling force to be exerted between the recording layer 4 and the reproducing layer 6. On the other hand, the repulsive force of the magnetostatic energy is the repulsive force which is based on the magnetostatic energy to be exerted between the overall magnetization of the trigger layer 5 and the overall magnetization of the reproducing layer 6 which are directed in the mutually opposite directions. As shown in FIG. 8B, the repulsive force of the magnetostatic energy is decreased as the magnetization of the trigger layer 5 is decreased in accordance with the approach to the reproducing temperature area from the low temperature area. However, the repulsive force of the magnetostatic energy is not zero even in the reproducing temperature area, which has a predetermined value. That is, the repulsive force of the magnetostatic energy is exerted on the magnetic domain 27 of the reproducing layer 6 disposed over the reproducing temperature area 11, for the following reason. That is, as shown in FIG. 8A, the magnetization of the magnetic domain 27 of the reproducing layer 6 in the reproducing temperature area 11 is directed in the direction opposite to that of the magnetization of the magnetic domain 28 of the recording layer 4 in the reproducing temperature area 11, and the repulsive force is exerted between these magnetic domains.

An interface area 14, which is disposed between the trigger layer 5 and the reproducing layer 6 as shown in FIG. 8A, is heated to a temperature in the vicinity of a temperature of the boundary between the low temperature area and the reproducing temperature area. The magnetostatic repulsive force exceeds the exchange coupling force in the interface area 14. In this situation, as shown in FIG. 9A, the repulsive force of the magnetostatic energy firstly exceeds the attracting force of the exchange energy in the magnetic domain 23′ disposed on the left side of the magnetic domain 23 of the reproducing layer 6. Therefore, the magnetic domain 23′ is reversed. The magnetic characteristic is adjusted so that the minimum magnetic domain diameter of the expanding reproducing layer 6 is larger than the minimum magnetic domain diameter of the recording magnetic domain, which is approximately the same as the light spot diameter. Therefore, the magnetic domain of the expanding reproducing layer 6 is expanded until arrival at the light spot diameter as indicated by the magnetic domain 23A shown in FIG. 9B. When the magnetic domain expansion is utilized as described above, it is possible to detect a large reproduced signal from the reproducing layer 6.

According to a verifying experiment performed by the present inventors, it has been revealed for the magneto-optical recording medium based on the Zero-Field MAMMOS that the operation to expand the magnetic domain transferred to the reproducing layer during the reproduction is affected by the temperature distribution in the thickness direction in the reproducing layer generated by the reproducing light beam and the magnetization distribution in the thickness direction induced thereby. In particular, it has been revealed that the magnetization distribution in the thickness direction in the reproducing layer is preferably constant during the reproduction in order to smoothly perform the operation to expand the magnetic domain of the reproducing layer. Further, it has been revealed that if the magnetization distribution in the thickness direction in the reproducing layer is not constant, then the operation to expand the magnetic domain is not performed smoothly, and the jitter of the reproduced signal is increased.

A specified explanation will be made below. In the case of the magneto-optical recording medium based on the Zero-Field MAMMOS subjected to the high density recording, information is reproduced by using the objective lens having the large numerical aperture. Therefore, the focal length is shortened for the reproducing light beam when the reproducing light beam is radiated. As a result, the difference in temperature is increased between the surface of the reproducing layer on the reproducing light beam-incoming side and the surface disposed on the side opposite thereto. Accordingly, the difference in magnitude of the magnetization is also increased between the surfaces of the reproducing layer, and the operation to expand the magnetic domain of the reproducing layer is not performed smoothly. In particular, the objective lens having a larger numerical aperture is necessarily used for the magneto-optical recording medium based on the Zero-Field MAMMOS of the type in which the reproducing light beam is allowed to come thereinto from the side opposite to the substrate (hereinafter referred to as “first surface type”) as compared with the magneto-optical recording medium of the type in which the reproducing light beam is allowed to come thereinto from the side of the substrate. Therefore, the difference in temperature is further increased between the surface of the reproducing layer on the reproducing light beam-incoming side and the surface disposed on the side opposite thereto. Further, the difference in magnitude of the magnetization is also further increased between the surfaces of the reproducing layer. Therefore, the following problem arises in the magneto-optical recording medium based on the Zero-Field MAMMOS of the first surface type. That is, the operation to expand the magnetic domain of the reproducing layer is not performed smoothly to a further extent, and the recording and reproduction characteristics are further deteriorated.

The magneto-optical recording medium based on the Zero-Field MAMMOS further comprises an enhancing layer which is formed of an SiN film and which is disposed adjacently on the surface of the reproducing layer on the side opposite the auxiliary magnetic layer. The reproducing layer is formed on the enhancing layer in the magneto-optical recording medium based on the Zero-Field MAMMOS of the type in which the reproducing light beam is allowed to come thereinto from the side of the substrate. According to a verifying experiment performed by the present inventors, it has been revealed that the rare earth metal, which is included in the rare earth transition metal for forming the reproducing layer, is selectively incorporated into the SiN film, when the reproducing layer, which is composed of the rare earth transition metal, is formed on the SiN film. That is, the composition ratio of the transition metal is increased in the composition of the surface of the reproducing layer disposed on the side of the SiN film (hereinafter referred to as “surface on the reproducing light beam-incoming side” as well) as compared with the composition of the reproducing layer disposed on the side opposite to the SiN film in the magneto-optical recording medium based on the Zero-Field MAMMOS of the type in which the reproducing light beam is allowed to come thereinto from the side of the substrate. Accordingly, it has been revealed for the magneto-optical recording medium based on the Zero-Field MAMMOS of the type in which the reproducing light beam is allowed to come thereinto from the side of the substrate that the jitter of the reproduced signal is decreased and the difference in magnetization between the surfaces of the reproducing layer is decreased even when the difference in temperature arises between the surfaces of the reproducing layer upon the irradiation with the reproducing light beam as compared with the magneto-optical recording medium based on the Zero-Field MAMMOS of the first surface type.

In the magneto-optical recording medium according to the first aspect of the present invention, the composition distribution in the thickness direction of the reproducing layer formed of the rare earth transition metal is regulated so that the magnetization distribution is approximately uniform in the thickness direction in the reproducing layer in response to the nonuniform temperature distribution generated in the thickness direction in the reproducing layer when the reproducing light beam is radiated. Specifically, the composition ratio of the transition metal at the surface of the reproducing layer on the reproducing light beam-incoming side is set to be higher than the composition ratio of the transition metal at the surface of the reproducing layer on the side opposite to the reproducing light beam-incoming side so that the difference is decreased between the magnitude of magnetization at the surface of the reproducing layer on the reproducing light beam-incoming side and the magnitude of magnetization at the surface on the side opposite to the reproducing light beam-incoming side when the reproducing layer is heated to a temperature in the vicinity of the reproducing temperature. Accordingly, in the magneto-optical recording medium of the present invention, the magnitude of the magnetization at the surface of the reproducing layer on the reproducing light beam-incoming side has a value which is approximate to that of the magnitude of the magnetization at the surface on the side opposite to the reproducing light beam-incoming side during the reproduction. Thus, the operation to expand the magnetic domain of the reproducing layer is performed smoothly, and it is possible to decrease the jitter of the reproduced signal.

A more specified explanation will now be made with reference to FIG. 4 about the magnetic characteristic of the reproducing layer of the magneto-optical recording medium according to the first aspect of the present invention. FIG. 4 shows the relationship between the temperature characteristic of the magnetization at the surface of the reproducing layer on the reproducing light beam-incoming side and the temperature characteristic of the magnetization at the surface of the reproducing layer on the side opposite to the reproducing light beam-incoming side. In FIG. 4, a curve (1) indicates the temperature characteristic of the magnetization at the surface of the reproducing layer on the side opposite to the reproducing light beam-incoming side, and a curve (2) indicates the temperature characteristic of the magnetization at the surface of the reproducing layer on the reproducing light beam-incoming side. The composition ratio of the transition metal at the surface of the reproducing layer on the reproducing light beam-incoming side is higher than the composition ratio of the transition metal at the surface of the reproducing layer on the side opposite to the reproducing light beam-incoming side. Therefore, as shown in FIG. 4, the Curie temperature (point at which the curve (2) intersects the horizontal axis) of the surface of the reproducing layer on the reproducing light beam-incoming side is higher than the Curie temperature (point at which the curve (1) intersects the horizontal axis) of the surface of the reproducing layer on the side opposite to the reproducing light beam-incoming side. However, during the reproduction of information, the temperature of the surface of the reproducing layer on the reproducing light beam-incoming side is higher than the temperature of the surface of the reproducing layer on the side opposite to the reproducing light beam-incoming side. On the other hand, when the temperature characteristic (curve (2)) of the magnetization at the surface of the reproducing layer on the reproducing light beam-incoming side is plotted in FIG. 4 with respect to the temperature of the surface of the reproducing layer on the side opposite to the reproducing light beam-incoming side, a temperature characteristic is obtained as indicated by a curve (3), which intersects the curve (1) at the reproducing temperature Tr. That is, in the magneto-optical recording medium according to the first aspect of the present invention, the composition ratios of the transition metals at the surface of the reproducing layer on the reproducing light beam-incoming side and at the surface on the side opposite to the reproducing light beam-incoming side are regulated respectively so that the difference is small (identical in FIG. 4) between the magnitude of the magnetization (curve (1)) at the surface of the reproducing layer on the side opposite to the reproducing light beam-incoming side and the magnitude of the magnetization (curve (3)) at the surface of the reproducing layer on the reproducing light beam-incoming side when the surface of the reproducing layer on the side opposite to the reproducing light beam-incoming side is heated to the reproducing temperature Tr. Therefore, the values of the magnitudes of the magnetization at the surfaces on the both sides of the reproducing layer are approximate to one another during the reproduction. Thus, the operation to expand the magnetic domain of the reproducing layer is performed smoothly, and it is possible to decrease the jitter of the reproduced signal.

In the magneto-optical recording medium according to the first aspect of the present invention, it is preferable that the composition ratio of the transition metal contained in the rare earth transition metal at the surface of the reproducing layer on the reproducing light beam-incoming side is higher by a range of 0.5 at. % to 4.5 at. % than the composition ratio of the transition metal contained in the rare earth transition metal at the surface on the side opposite to the reproducing light beam-incoming side. It is especially preferable that the former composition ratio is higher by a range of 1.5 at. % to 3.5 at. % than the latter composition ratio.

In the magneto-optical recording medium according to the first aspect of the present invention, it is preferable that an increment amount of a composition ratio of the transition metal at an intermediate position in a thickness direction in the reproducing layer with respect to the composition ratio of the transition metal at the surface of the reproducing layer on the side opposite to the reproducing light beam-incoming side is not more than ¼ of an increment amount of the composition ratio of the transition metal at the surface of the reproducing layer on the reproducing light beam-incoming side with respect to the composition ratio of the transition metal at the surface of the reproducing layer on the side opposite to the reproducing light beam-incoming side. It is especially preferable that the former increment amount is not more than ⅛ of the latter increment amount.

In the magneto-optical recording medium according to the first aspect of the present invention, it is preferable that the composition ratio of the transition metal contained in the rare earth transition metal which forms the reproducing layer is increased continuously at positions nearer to the surface of the reproducing layer on the reproducing light beam-incoming side in a thickness direction in the reproducing layer.

According to a second aspect of the present invention, there is provided a magneto-optical recording medium wherein a magnetic domain is expanded to reproduce information from the expanded magnetic domain by irradiating the magneto-optical recording medium with a reproducing light beam comprising a recording layer which is formed of a rare earth transition metal; a reproducing layer which is formed of a rare earth transition metal; and an auxiliary magnetic layer which is formed of a magnetic material and which is arranged between the recording layer and the reproducing layer, wherein the reproducing layer is formed with a first reproducing layer and a second reproducing layer, the second reproducing layer is arranged on a reproducing light beam-incoming side as compared with the first reproducing layer, and a transition metal, which is contained in the rare earth transition metal which forms the second reproducing layer, has a composition ratio which is higher than a composition ratio of a transition metal which is contained in the rare earth transition metal which forms the first reproducing layer.

In the magneto-optical recording medium according to the second aspect of the present invention, the recording layer, the auxiliary magnetic layer, and the reproducing layer are subjected to magnetic exchange coupling in a state in which the magneto-optical recording medium is not irradiated with the reproducing light beam; the magnetic domain, which is transferred from the recording layer to the reproducing layer, is expanded to reproduce information from the expanded magnetic domain by irradiating the magneto-optical recording medium with the reproducing light beam to heat to a temperature not less than a temperature at which an exchange coupling force between the recording layer and the reproducing layer is cut off. The reproducing layer comprises the first reproducing layer and the second reproducing layer, and each of them is formed of the rare earth transition metal. The second reproducing layer is arranged on the side nearer to the reproducing light beam-incoming side as compared with the first reproducing layer. The composition ratio of the transition metal contained in the second reproducing layer is set to be higher than the composition ratio of the transition metal contained in the first reproducing layer. The difference in composition ratio of the transition metal between the first reproducing layer and the second reproducing layer is regulated so that the difference is decreased between the magnitude of the magnetization at the surface of the second reproducing layer on the reproducing light beam-incoming side and the magnitude of the magnetization at the surface of the first reproducing layer on the side opposite to the reproducing light beam-incoming side in response to the nonuniform temperature distribution generated in the thickness direction in the reproducing layer when the reproducing light beam is radiated. Therefore, in the magneto-optical recording medium according to the second aspect of the present invention, even when the nonuniform temperature distribution is generated in the thickness direction in the reproducing layer during the reproduction, the value of the magnitude of the magnetization at the surface of the reproducing layer on the reproducing light beam-incoming side is approximate to the value of the magnitude of the magnetization at the surface on the side opposite to the reproducing light beam-incoming side. Thus, the operation to expand the magnetic domain of the reproducing layer is performed smoothly, and it is possible to decrease the jitter of the reproduced signal.

In the magneto-optical recording medium according to the second aspect of the present invention, it is preferable that the composition ratio of the transition metal contained in the rare earth transition metal which forms the second reproducing layer is higher by a range of 0.5 at. % to 4.5 at. % than the composition ratio of the transition metal contained in the rare earth transition metal which forms the first reproducing layer. It is especially preferable that the former composition ratio is higher by a range of 1.5 at. % to 3.5 at. % than the latter composition ratio. It is preferable that the second reproducing layer has a thickness which is not more than a half of a thickness of the first reproducing layer.

It is preferable that each of the magneto-optical recording media according to the first and second aspects of the present invention is a magneto-optical recording medium of the type in which the reproducing light beam is radiated directly onto the stacked or laminated film such as the reproducing layer, the auxiliary magnetic layer, and the recording layer without passing through a substrate, i.e. a magneto-optical recording medium of the first surface type.

It is preferable that each of the magneto-optical recording media according to the first and second aspects of the present invention further comprises an enhancing layer which is formed of an SiN film and which is disposed on the surface of the reproducing layer on a side opposite the auxiliary magnetic layer.

According to a third aspect of the present invention, there is provided a method for producing the magneto-optical recording medium according to the first or second aspect, comprising the steps of forming the reproducing layer, the auxiliary magnetic layer, and the recording layer by performing sputtering with targets of transition metals and rare earth metals which form the reproducing layer, the auxiliary magnetic layer, and the recording layer, wherein an electric power, which is input to the target of the transition metal or the rare earth metal which forms the reproducing layer, is changed according to a sputtering time (time schedule) when the reproducing layer is formed by performing the sputtering.

In the method for producing the magneto-optical recording medium of the present invention, the electric power, which is input to the target of the transition metal, is increased according to the sputtering time, or the electric power, which is input to the target of the rare earth metal, is decreased according to the sputtering time when the reproducing layer, which is composed of the rare earth transition metal, is formed by performing the sputtering. Accordingly, the control is made so that the composition ratio of the transition metal at the surface of the reproducing layer on the reproducing light beam-incoming side is higher than the composition ratio of the transition metal at the surface of the reproducing layer on the side opposite to the reproducing light beam-incoming side. Accordingly, it is possible to manufacture the magneto-optical recording medium in which the jitter of the reproduced signal is small.

A method is available to regulate the composition distribution in the thickness direction of the reproducing layer, in which the gas pressure to be used for the sputtering may be regulated. The rare earth metal tends to be oxidized as compared with the transition metal. Therefore, when the gas pressure is increased, the composition ratio of the transition metal is increased. Therefore, the composition in the thickness direction of the reproducing layer can be regulated by changing the gas pressure according to the sputtering time. Another method is also available to regulate the composition distribution in the thickness direction of the reproducing layer, in which the gas type or species to be used for the sputtering may be changed according to the sputtering time. The composition ratio of the transition metal of the reproducing layer can be regulated, for example, by making the change into a gas having a higher partial pressure of oxygen during the sputtering. When the reproducing layer is formed by successively depositing respective materials of constitutive elements of the rare earth transition metal which forms the reproducing layer by performing the sputtering, the composition distribution in the thickness direction of the reproducing layer may be regulated by changing the stacking cycle of each of the materials of constitutive elements according to the sputtering time. When the stacking cycle of each of the materials of constitutive elements for forming the reproducing layer is changed, the amounts of deposition of the transition metal and the rare earth metal are changed. Therefore, it is possible to regulate the composition ratio of the reproducing layer. Alternatively, the amount of mixed or added oxygen per unit of stacking cycle may be changed along with the thickness.

### BRIEF DESCRIPTION OF THE DRAWINGS

FIG. 1 shows a schematic sectional view illustrating a magneto-optical recording medium manufactured in a first embodiment.

FIG. 2 shows a time schedule for the electric power to be input to respective simple substance targets during the formation of the reproducing layer with respect to the thickness of the reproducing layer.

FIG. 3 shows a distribution in the thickness direction of the difference of the composition ratio of the transition metal contained in the reproducing layer with respect to the composition ratio of the transition metal at the surface of the reproducing layer on the side of the trigger layer.

FIG. 4 shows the relationship between the temperature characteristic of the magnetization at the surface of the reproducing layer on the reproducing light beam-incoming side and the temperature characteristic of the magnetization at the surface on the side opposite to the reproducing light beam-incoming side.

FIG. 5 shows a schematic sectional view illustrating a magneto-optical recording medium manufactured in a second embodiment.

FIG. 6 illustrates the principle of reproduction on the magneto-optical recording medium based on the Zero-Field MAMMOS, depicting the situations of magnetization of the reproducing layer, the trigger layer, and the recording layer before being irradiated with the reproducing light beam.

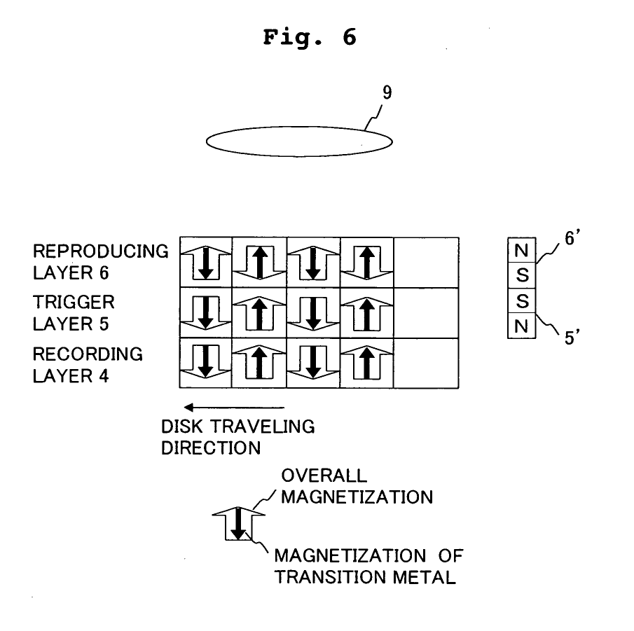

FIG. 7 illustrates the principle of reproduction on the magneto-optical recording medium based on the Zero-Field MAMMOS, depicting situations in which the reproducing light beam is radiated.

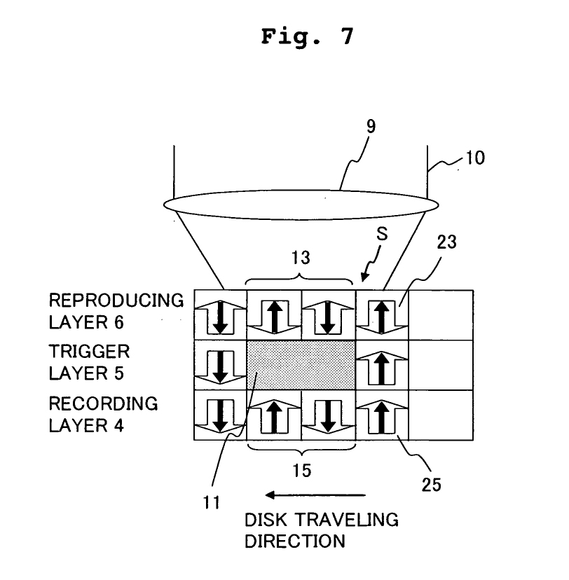

FIG. 8 illustrates the principle of reproduction on the magneto-optical recording medium based on the Zero-Field MAMMOS, wherein FIGS. 8A and 8B depict the relationship between the repulsive force of the magnetostatic energy and the attracting force of the exchange energy when the magnetic domain in the reproducing layer is not expanded.

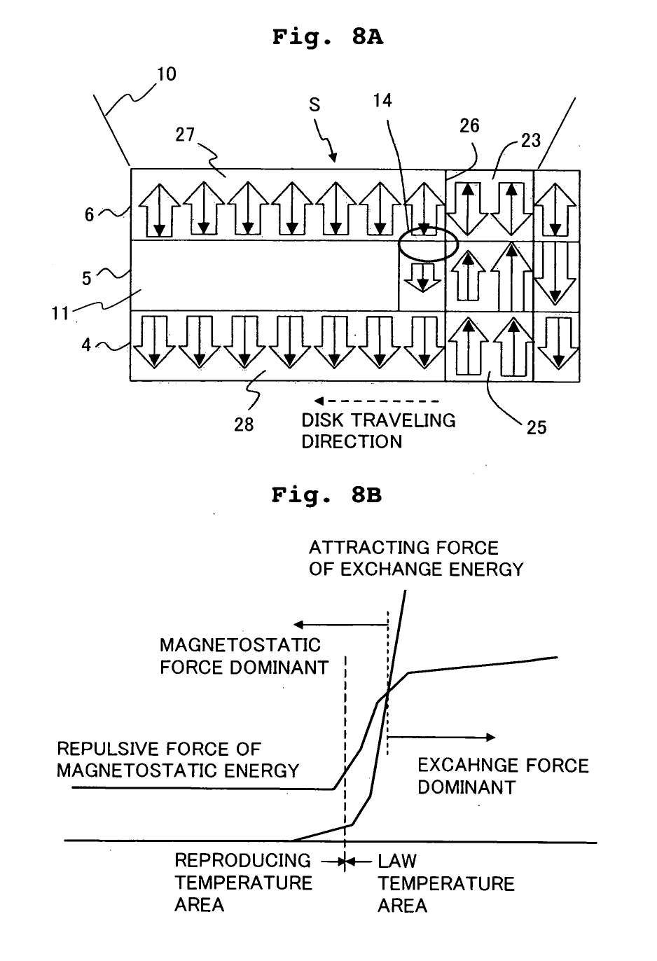

FIG. 9 illustrates the principle of reproduction on the magneto-optical recording medium based on the Zero-Field MAMMOS, wherein FIGS. 9A and 9B depict situations in which the magnetic domain of the reproducing layer is expanded.

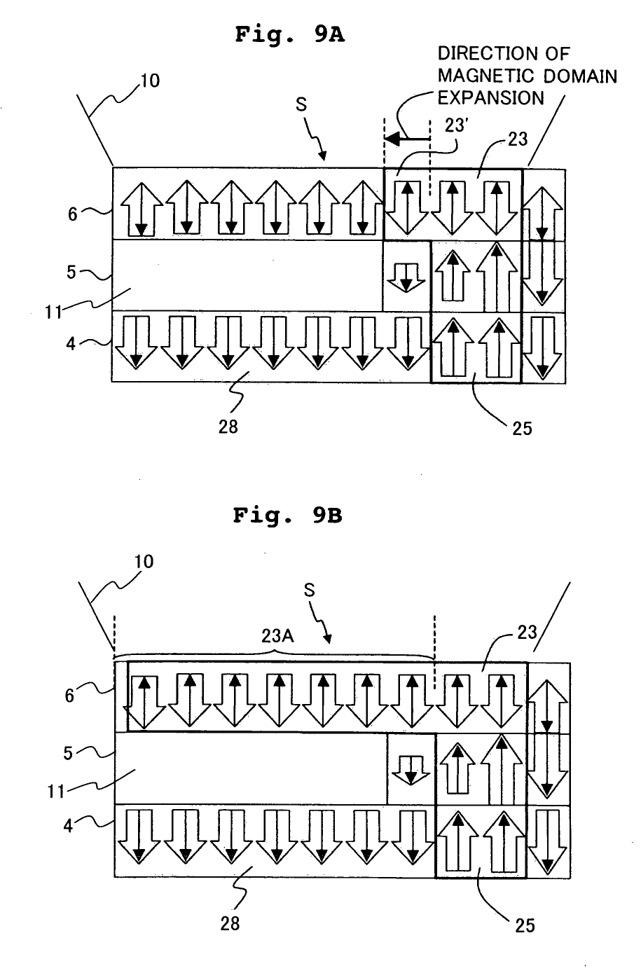

### DESCRIPTION OF THE PREFERRED EMBODIMENTS

The magneto-optical recording medium and the method for producing the same according to the present invention will be specifically explained below as exemplified by embodiments and examples. However, the present invention is not limited thereto.

### First Embodiment

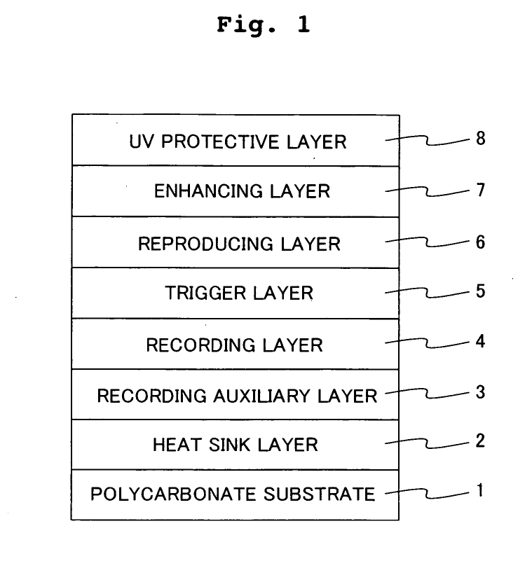

In this first embodiment, a magneto-optical recording medium based on the Zero-Field MAMMOS of the type in which the film surface is directly irradiated with the reproducing light beam without passing through the substrate, i.e., of the first surface type was manufactured. FIG. 1 shows a structure of the magneto-optical recording medium manufactured in this embodiment. As shown in FIG. 1, the magneto-optical recording medium has the structure in which a heat sink layer 2, a recording auxiliary layer 3, a recording layer 4, a trigger layer 5, a reproducing layer 6, an enhancing layer 7, and a protective layer 8 are successively stacked or laminated in this order on a substrate 1. The heat sink layer 2 is a layer which adjusts the thermal sensitivity of the medium during the recording and reproduction of information. The recording auxiliary layer 3 is a magnetic layer which functions so that the recording magnetic domain is formed in the recording layer with a smaller modulated magnetic field. The recording layer 4 is a layer in which information is recorded as magnetization information. The trigger layer 5 is a layer which controls the magnetic exchange coupling force between the recording layer 4 and the reproducing layer 6 as described later on. The reproducing layer 6 is a layer in which the magnetic domain transferred from the recording layer 4 is expanded. However, the recording layer 4 and the reproducing layer 6 are magnetically subjected to the exchange coupling via the trigger layer 5 at a temperature which is sufficiently lower than the Curie temperature of the trigger layer 5. The enhancing layer 7 is a layer in which the reproducing light beam is subjected to the multiple interference in the layer to effectively increase the Kerr rotation angle detected during the reproduction of information. The protective layer 8 is a layer which protects the respective layers 2 to 7 successively stacked on the substrate 1.

An explanation will be made below about a method for producing the magneto-optical recording medium manufactured in this embodiment. At first, a transparent polycarbonate substrate was used for the substrate 1. A concave/convex pattern, which corresponded to a tracking groove and pits for generating a clock signal, was formed on the surface of the substrate 1 by using an injection molding machine (not shown).

Subsequently, the respective layers 2 to 7 of the magneto-optical recording medium were successively formed on the surface of the substrate 1 on the side on which the concave/convex pattern was formed, by using a sputtering apparatus (not shown). At first, an AlTiSi film was formed as the heat sink layer 2 to have a thickness of 40 nm on the substrate 1. As for the film formation method, an alloy target of AlTi and a simple substance target of Si were subjected to the co-sputtering to form the film.

Subsequently, a GdFeCo film was formed as the recording auxiliary layer 3 to have a thickness of 10 nm on the heat sink layer 2. As for the film formation method, simple substance targets of Gd, Fe, and Co were subjected to the co-sputtering to form the film. The composition of the recording auxiliary layer 3 was adjusted so that the GdFeCo film had the in-plane magnetization, the compensation temperature was not more than room temperature, and the Curie temperature was 270° C.

Subsequently, a TbFeCo film was formed as the recording layer 4 to have a thickness of 60 nm on the recording auxiliary layer 3. As for the film formation method, simple substance targets of Tb, Fe, and Co were subjected to the co-sputtering to form the film. The composition of the recording layer 4 was adjusted so that the TbFeCo film had the perpendicular magnetization in which the transition metal was dominant from room temperature to the Curie temperature, the compensation temperature was about 25° C., and the Curie temperature was 250° C.

Subsequently, a TbFe film was formed as the trigger layer 5 to have a thickness of 10 nm on the recording layer 4. As for the film formation method, simple substance targets of Tb and Fe were subjected to the co-sputtering to form the film. The TbFe film had the magnetization in which the transition metal was dominant from room temperature to the Curie temperature, and the TbFe film exhibited the perpendicular magnetization at a temperature which was sufficiently lower than the Curie temperature. In this embodiment, the composition of the trigger layer 5 was adjusted so that the compensation temperature of the trigger layer 5 was not more than room temperature.

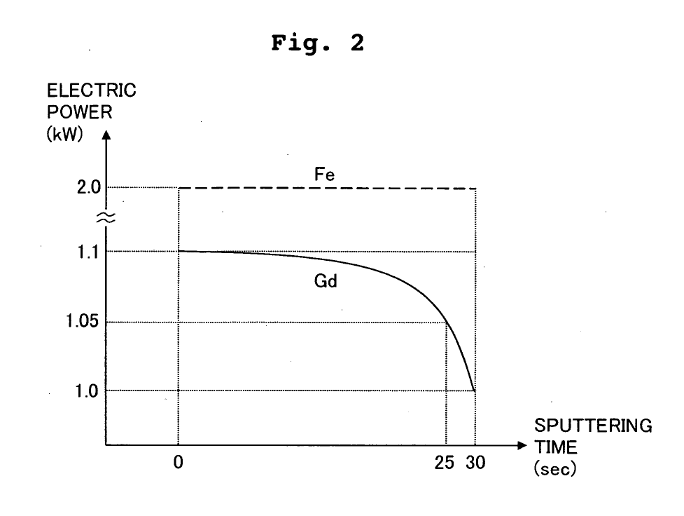

Further, a GdFeCo film was formed as the reproducing layer 6 to have a thickness of 30 nm on the trigger layer 5. As for the film formation method, simple substance targets of Gd, Fe, and Co were subjected to the co-sputtering to form the film. In this process, the electric power, which was input to each of the simple substance targets of Gd and Fe, was input in accordance with a time schedule as shown in FIG. 2. A solid line shown in FIG. 2 indicates the change of the input electric power with respect to the sputtering time for the rare earth metal Gd target, and a broken line indicates the change of the input electric power with respect to the sputtering time for the transition metal Fe target. As shown in FIG. 2, the input electric power for the Gd target was exponentially decreased to 1.1 to 1.0 kW. On the other hand, the input electric power for the Fe target was constant to be 2.0 kW irrelevant to the sputtering time. In this embodiment, the input electric power for the Co target was constant to be about 100 W irrelevant to the sputtering time (not shown).

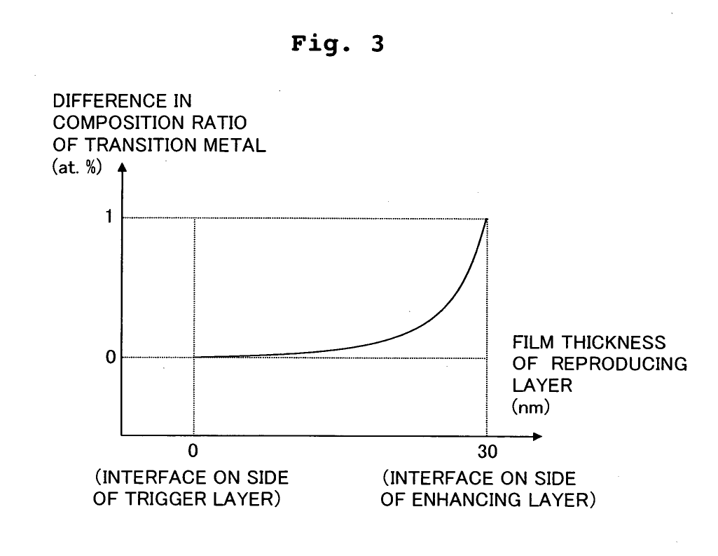

As a result of the formation of the reproducing layer 6 in accordance with the method as described above, the distribution in the thickness direction of the difference of the composition ratio of the transition metal in the reproducing layer with respect to the composition ratio of the transition metal at the surface of the reproducing layer on the side of the trigger layer 5 resided in a composition distribution as indicated by a solid line shown in FIG. 3. In the magneto-optical recording medium manufactured in this embodiment, as shown in FIG. 3, the difference in composition ratio of the transition metal in the reproducing layer is increased exponentially from the surface on the side of the trigger layer 5 (area of thicknesses of about 0 to 5 nm) to the surface on the side of the enhancing layer 7 (area of thicknesses of about 25 to 30 nm). In this embodiment, the difference between the composition ratio of the transition metal at the surface of the reproducing layer 6 on the side of the trigger layer 5 and the composition ratio of the transition metal at the surface on the side of the enhancing layer 7 was 1.0 at. % as shown in FIG. 3. As for the reproducing layer 6 of the magneto-optical recording medium formed in this embodiment, the Curie temperature of the reproducing layer at the surface on the side of the trigger layer 5 was about 260° C., and the compensation temperature was not less than the Curie temperature. On the other hand, the Curie temperature of the reproducing layer at the surface on the side of the enhancing layer 7 was about 280° C., and the compensation temperature was not less than the Curie temperature. The reproducing layer 6 was a perpendicular magnetized film which exhibited the rare earth metal-dominant ferri-magnetization from room temperature to the Curie temperature.

Subsequently, an SiN film was formed as the enhancing layer 7 to have a thickness of 35 nm on the reproducing layer 6. As for the film formation method, an Si target was sputtered in an Ar+N₂ atmosphere to form the film. Finally, an acrylic UV-curable resin was applied as the protective layer 8 onto the enhancing layer 7, followed by being irradiated and cured with the ultraviolet light to form the film. The thickness of the protective layer 8 was 15 μm. The magneto-optical recording medium based on the Zero-Field MAMMOS of the first surface type shown in FIG. 1 was obtained in accordance with the production method as described above.

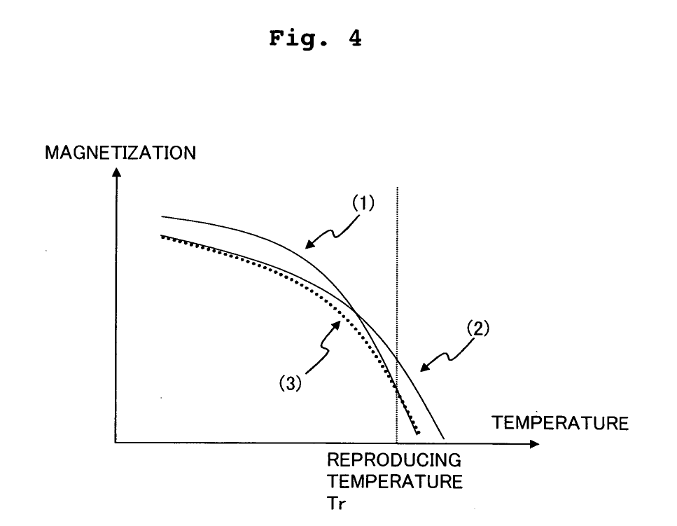

In the magneto-optical recording medium manufactured by the production method as described above, the relationship between the temperature characteristic of the magnetization at the surface of the reproducing layer on the side of the trigger layer and the temperature characteristic of the magnetization at the surface of the reproducing layer on the side of the enhancing layer was as shown in FIG. 4. In FIG. 4, the curve (1) indicates the temperature characteristic of the magnetization at the surface of the reproducing layer on the side of the trigger layer, and the curve (2) indicates the temperature characteristic of the magnetization at the surface of the reproducing layer on the side of the enhancing layer. The composition ratio of the transition metal at the surface of the reproducing layer on the side of the enhancing layer is higher than the composition ratio of the transition metal at the surface of the reproducing layer on the side of the trigger layer. Therefore, as shown in FIG. 4, the Curie temperature (point at which the curve (2) intersects the horizontal axis) at the surface of the reproducing layer on the side of the enhancing layer is higher than the Curie temperature (point at which the curve (1) intersects the horizontal axis) at the surface of the reproducing layer on the side of the trigger layer. However, during the reproduction of information, the surface of the reproducing layer on the side of the enhancing layer is disposed on the reproducing light beam-incoming side. Therefore, the temperature of the surface of the reproducing layer on the side of the enhancing layer is higher than the temperature of the surface of the reproducing layer on the side of the trigger layer. Therefore, when the temperature characteristic (curve (2)) of the magnetization at the surface of the reproducing layer on the side of the enhancing layer is plotted in FIG. 4 with respect to the temperature of the surface of the reproducing layer on the side of the trigger layer, the temperature characteristic of the magnetization as indicated by the curve (3) is obtained. In the magneto-optical recording medium manufactured in this embodiment, the composition ratios of the transition metals at the surface of the reproducing layer on the side of the trigger layer and the surface on the side of the enhancing layer are controlled respectively so that the magnitude of the magnetization at the surface of the reproducing layer on the side of the trigger layer (curve (1)) is approximately equal to the magnitude of the magnetization at the surface of the reproducing layer on the side of the enhancing layer (curve (3)) when the surface of the reproducing layer on the side of the trigger layer is heated to the reproducing temperature Tr. That is, in the magneto-optical recording medium based on the Zero-Field MAMMOS manufactured in this embodiment, the value of the magnitude of the magnetization at the surface of the reproducing layer on the side of the trigger layer is approximately the same as the value of the magnitude of the magnetization at the surface of the reproducing layer on the side of the enhancing layer during the reproduction. Therefore, the magnetic domain in the reproducing layer, which is transferred from the recording layer, is smoothly expanded during the reproduction. Thus, the jitter of the reproduced signal is decreased.

In the first embodiment, various magneto-optical recording media were manufactured, in which the composition ratio of the transition metal at the surface of the reproducing layer 6 on the side of the trigger layer 5 was higher by a range of 0.5 to 5 at. % than the composition ratio of the transition metal at the surface on the side of the enhancing layer 7. The electric signal characteristics of the manufactured magneto-optical recording media were evaluated.

A recording and reproducing apparatus (not shown), which was provided with a laser light source having a wavelength of 405 nm and an optical head having an objective lens with a numerical aperture of 0.9, was used to evaluate the electric signals obtained from the various magneto-optical recording media manufactured in this embodiment. The magnetic field for recording data was generated by allowing the current to flow through a coil disposed proximately to the magneto-optical recording medium. When the data was recorded, then the current allowed to flow through the coil was modulated in accordance with the recording data to apply the magnetic field, and the data was recorded on the magneto-optical recording medium by radiating recording light pulses. However, the recording data resided in repeating marks of 0.1 μm. The linear velocity of the magneto-optical recording medium was 6 m/s, and the recording power and the reproducing power were adjusted so that the electric signal characteristic was optimized. In order to evaluate the electric signal characteristic in this embodiment, the jitter was measured and the error rate was measured. When the jitter was measured, the reproduced signal was sliced at a certain voltage value on the basis of an optimum level for judging the signal to measure the jitter of the reproduced signal at the slice position. When the error rate was measured, the measurement was performed under a condition in which the bit error rate of the reproduced signal was maximally lowered by using an equalizer having an appropriate boost value and a cutoff value.

Table 1 shows results of the measurement of the jitter for the various magneto-optical recording media manufactured in this embodiment. In Table 1, the difference in composition ratio of the transition metal (B−A) (at. %) is the difference between the composition ratio A of the transition metal at the surface (area having thicknesses of about 0 to 5 nm of the reproducing layer shown in FIG. 3) of the reproducing layer on the side of the trigger layer and the composition ratio B of the transition metal at the surface (area having thicknesses of about 25 to 30 nm of the reproducing layer shown in FIG. 3) on the side of the enhancing layer. In Table 1, the jitter values were written for the differences in composition ratio (B−A) for which the jitters were successfully measured. The jitter value, which was obtained when the composition of the reproducing layer was not changed in the thickness direction, was 15%.

TABLE 1

Difference in composition
ratio of transition
metal (B − A) (at. %)

| | 0.5 | 1.5 | 2.5 | 3.5 | 4.5 | 5 |
|---|---|---|---|---|---|---|
| Jitter (%) | 14.0 | 12.5 | 12.0 | 13.5 | 14.2 | |

As clarified from Table 1, it has been revealed that the jitter characteristic is improved so that the jitter value is smaller than 15% within a range of the difference in composition ratio (B−A) of 0.5 to 4.5 at. %. In particular, it has been revealed that the jitter value is smaller than 14% and the jitter characteristic is further improved when the difference in composition ratio (B−A) is 1.5 to 3.5 at. %.

On the other hand, Table 2 shows results of the measurement of the error rate for the various magneto-optical recording media manufactured in this embodiment. In Table 2, the bit error rates were written for the differences in composition ratio (B−A) for which the bit error rates were successfully measured. The bit error rate, which was obtained when the composition of the reproducing layer was not changed in the thickness direction, was 5.0E−4.

TABLE 2

| | Difference in composition | | | | | |
|---|---|---|---|---|---|---|
| | ratio of transition | | | | | |
| | metal (B − A) (at. %) | | | | | |
| | 0.5 | 1.5 | 2.5 | 3.5 | 4.5 | 5 |
| Error rate | 3.0E−4 | 9.0E−5 | 8.5E−5 | 2.5E−4 | 4.8E−4 | |

As clarified from Table 2, the bit error rate is smaller than 5.0E−4 and the error value is improved when the difference in composition ratio (B−A) is 0.5 to 4.5 at. %. In particular, it has been revealed that the bit error rate is smaller than 3.0E−4 and the error value is greatly improved when the difference in composition ratio (B−A) is 1.5 to 3.5 at. %.

### Second Embodiment

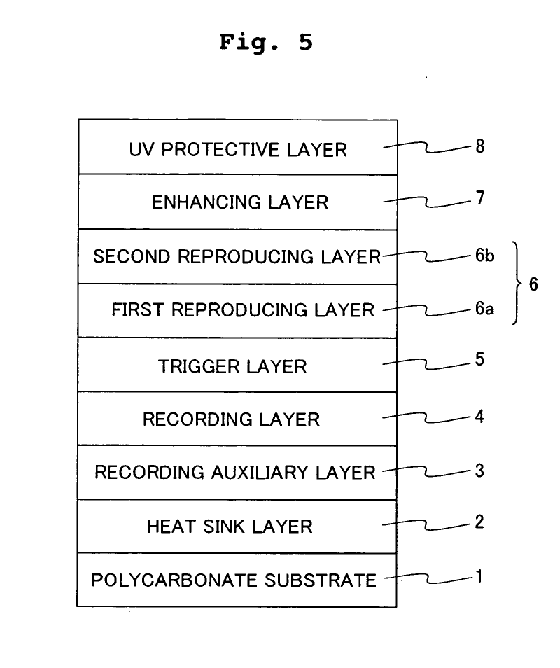

In this second embodiment, a magneto-optical recording medium based on the Zero-Field MAMMOS of the first surface type was manufactured in the same manner as in the first embodiment. FIG. 5 shows a structure of the magneto-optical recording medium manufactured in this embodiment. As shown in FIG. 5, the magneto-optical recording medium manufactured in this embodiment has the structure in which a heat sink layer 2, a recording auxiliary layer 3, a recording layer 4, a trigger layer 5, a first reproducing layer 6a, a second reproducing layer 6b, an enhancing layer 7, and a protective layer 8 are successively stacked or laminated in this order on a substrate 1.

The magneto-optical recording medium of the second embodiment was manufactured in the same manner as in the first embodiment except that the reproducing layer 6 was formed with the first reproducing layer 6a and the second reproducing layer 6b. The first reproducing layer 6a and the second reproducing layer 6b were formed by using a sputtering apparatus (not shown). The following method was adopted. At first, a GdFeCo film was formed as the first reproducing layer 6a to have a thickness of 25 nm on the trigger layer 5. As for the film formation method, simple substance targets of Gd, Fe, and Co were subjected to the co-sputtering to form the film. During this process, the electric powers, which were input to the respective targets of Gd, Fe, and Co, were constant, i.e., 1.1 kW, 2.0 kW, and 100 W respectively. Subsequently, a GdFeCo film was formed as the second reproducing layer 6b to have a thickness of 5 nm on the first reproducing layer 6a. As for the film formation method, simple substance targets of Gd, Fe, and Co were subjected to the co-sputtering to form the film. However, when the second reproducing layer 6b was formed, the electric powers, which were applied to the respective targets of Gd, Fe, and Co, were constant, i.e., 1.0 kW, 2.0 kW, and 100 W, respectively. That is, the electric power, which was input to the target of the rare earth metal Gd when the second reproducing layer 6b was formed by performing the sputtering, was made to be smaller than the electric power which was input to the target of the rare earth metal Gd when the first reproducing layer 6a was formed. Accordingly, the second reproducing layer 6b was formed so that the composition ratio of the transition metal of the second reproducing layer 6b was larger than the composition ratio of the transition metal of the first reproducing layer 6a. The difference in composition ratio of the transition metal between the first reproducing layer 6a and the second reproducing layer 6b formed by the method as described above was 1.0 at. %. As for the first reproducing layer 6a, the Curie temperature was about 260° C., the compensation temperature was not less than the Curie temperature, and the rare earth metal-dominant ferri-magnetization was exhibited from room temperature to the Curie temperature. On the other hand, as for the second reproducing layer 6b, the Curie temperature was about 300° C., the compensation temperature was not less than the Curie temperature, and the rare earth metal-dominant ferri-magnetization was exhibited from room temperature to the Curie temperature.

The relationship of the temperature characteristic of the magnetization is given as shown in FIG. 4 in relation to the first reproducing layer 6a and the second reproducing layer 6b of the magneto-optical recording medium manufactured by the production method as described above in the same manner as in the first embodiment. The temperature characteristic of the magnetization of the first reproducing layer 6a is given by the characteristic represented by the curve (1) shown in FIG. 4, and the temperature characteristic of the magnetization of the second reproducing layer 6b is represented by the curve (2). When the reproducing light beam is radiated, the second reproducing layer 6b, which is disposed on the reproducing light beam-incoming side, has a temperature which is higher than that of the first reproducing layer 6a. Therefore, when the temperature characteristic (curve (2)) of the magnetization of the second reproducing layer 6b with respect to the temperature of the first reproducing layer 6a is plotted in FIG. 4 in the same manner as in the first embodiment, the temperature characteristic of the magnetization as indicated by the curve (3) is obtained. In the magneto-optical recording medium manufactured in this embodiment, the difference in composition ratio of the transition metal between the first reproducing layer 6a and the second reproducing layer 6b is adjusted so that the magnitude of the magnetization at the surface of the second reproducing layer 6b on the side of the enhancing layer 7 (surface of the reproducing layer 6 on the reproducing light beam-incoming side) is approximately equal to the magnitude of the magnetization at the surface of the first reproducing layer 6a on the side of the trigger layer 5 when the first reproducing layer 6a is heated to have a temperature in the vicinity of the reproducing temperature Tr. That is, in the magneto-optical recording medium based on the Zero-Field MAMMOS manufactured in this embodiment, the value of the magnitude of the magnetization at the surface of the second reproducing layer 6b on the side of the enhancing layer 7 (surface of the reproducing layer 6 on the reproducing light beam-incoming side) is approximately the same as the value of the magnitude of the magnetization at the surface of the first reproducing layer 6a on the side of the trigger layer 5. Accordingly, the magnetic domain of the reproducing layer, which is transferred from the recording layer, is smoothly expanded. Thus, the jitter of the reproduced signal is decreased.

In the second embodiment, various magneto-optical recording media were manufactured, in which the composition ratio of the transition metal of the second reproducing layer was increased by a range of 0.5 to 5 at. % as compared with the composition ratio of the transition metal of the first reproducing layer, and the thickness of the second reproducing layer was changed within a range of 1 to 15 nm. The electric signal characteristics of the manufactured magneto-optical recording media were evaluated. However, the thickness of the first reproducing layer was constant to be 25 nm. In this embodiment, the jitter was measured and the error rate was measured as the electric signal characteristic in the same manner as in the first embodiment. The recording data resided in repeating marks of 0.1 μm.

Table 3 shows results of the measurement of the jitter for the various magneto-optical recording media manufactured in this embodiment. In Table 3, the difference in composition ratio of the transition metal (B−A) (at. %) is the difference between the composition ratio B of the transition metal of the second reproducing layer and the composition ratio A of the transition metal of the first reproducing layer. In Table 3, the jitter values were written for the thicknesses of the second reproducing layers and the differences in composition ratio (B−A) for which the jitters were successfully measured. The jitter value, which was obtained when the composition ratio of the transition metal of the first reproducing layer was the same as that of the second reproducing layer, was 15%.

TABLE 3

| | | Difference in composition | | | | | |
|---|---|---|---|---|---|---|---|
| | | ratio of transition | | | | | |
| | | metal (B − A) (at. %) | | | | | |
| Jitter (%) | | 0.5 | 1.5 | 2.5 | 3.5 | 4.5 | 5 |
| Thickness | 1 | | 14.5 | 14.5 | 14.0 | 14.8 | |
| of second | 3 | 14.2 | 12.5 | 12.5 | 13.5 | 14.6 | 15.0 |
| reproducing | 5 | 14.2 | 12.5 | 12.9 | 13.8 | 14.5 | 15.0 |
| layer (nm) | 10 | | 14.0 | 14.0 | 14.5 | 14.8 | |
| | 15 | | | | | | |

As clarified from Table 3, it has been revealed for the magneto-optical recording medium manufactured in this embodiment that the jitter characteristic is improved so that the jitter value is smaller than 15% when the difference in composition ratio of the transition metal (B−A) is 0.5 to 4.5 at. % and the thickness of the second reproducing layer is within a range of not more than 10 nm. In particular, it has been revealed that the jitter value is smaller than 14% and the jitter characteristic is further improved when the difference in composition ratio (B−A) is 1.5 to 3.5 at. % and the thickness of the second reproducing layer is within a range of 3 to 5 nm.

On the other hand, Table 4 shows results of the measurement of the error rate for the various magneto-optical recording media manufactured in this embodiment. In Table 4, the bit error rate values were written for the thicknesses of the second reproducing layers and the differences in composition ratio (B−A) for which the bit error rates were successfully measured. The value of the bit error rate, which was obtained when the composition ratio of the transition metal of the first reproducing layer was the same as that of the second reproducing layer, was 5.0E−4.

TABLE 4

| | | Difference in composition | | | | | |
|---|---|---|---|---|---|---|---|
| | | ratio of transition | | | | | |
| | | metal (B − A) (at. %) | | | | | |
| Error rate | | 0.5 | 1.5 | 2.5 | 3.5 | 4.5 | 5 |
| Thickness | 1 | | 5.0E−4 | 3.0E−4 | 4.0E−4 | | |
| of second | 3 | 4.0E−4 | 9.5E−5 | 9.0E−5 | 3.0E−4 | 4.8E−4 | |
| reproducing | 5 | 4.0E−4 | 9.0E−5 | 9.0E−5 | 4.0E−4 | 1.0E−3 | |
| layer (nm) | 10 | | 3.0E−4 | 4.0E−4 | | | |
| | 15 | | | | | | |

As clarified from Table 4, it has been revealed for the magneto-optical recording medium manufactured in this embodiment that the value of the bit error rate is smaller than 5.0E−4 and the error rate characteristic is improved when the difference in composition ratio of the transition metal (B−A) between the second reproducing layer and the first reproducing layer is 0.5 to 4.5 at. % and the thickness of the second reproducing layer is within a range of not more than 10 nm. In particular, it has been revealed that the value of the bit error rate is not more than 4.0E−4 and the error rate characteristic is further improved when the difference in composition ratio of the transition metal (B−A) is 1.5 to 3.5 at. % and the thickness of the second reproducing layer is within a range of 3 to 5 nm.

The first and second embodiments have been explained as exemplified by the magneto-optical recording media based on the Zero-Field MAMMOS of the first surface type in which the reproducing light beam is directly radiated onto the film surface without passing through the substrate. However, the present invention is not limited thereto. The effect, which is the same as or equivalent to those obtained in the first and second embodiments, has been also confirmed as a result of the investigation about a magneto-optical recording medium based on the Zero-Field MAMMOS of the type in which the reproducing light beam is radiated through the substrate.

The reproducing layer was formed such that the input electric power was lowered for the target of the rare earth metal among the respective simple substance targets when the reproducing layer was formed by performing the co-sputtering in order that the composition ratio of the transition metal at the surface of the reproducing layer on the reproducing light beam-incoming side was made to be larger than the composition ratio of the transition metal at the surface on the side opposite to the reproducing light beam-incoming side in the first embodiment described above, and in order that the composition ratio of the transition metal of the second reproducing layer was made to be larger than the composition ratio of the transition metal of the first reproducing layer in the second embodiment. However, the present invention is not limited thereto. The gas pressure or the gas type or species may be changed during the sputtering. When the method, in which the reproducing layer is formed by sequentially sputtering simple substance targets of respective constitutive element materials for forming the reproducing layer, is used, the composition ratio of the transition metal may be regulated by changing the stacking cycle for each of the constitutive element materials.

According to the magneto-optical recording medium and the method for producing the same concerning the present invention, the difference in the magnitude of the magnetization is decreased between the surface of the reproducing layer on the reproducing light beam-incoming side and the surface on the side opposite thereto, because the reproducing layer is formed so that the composition ratio of the transition metal at the surface of the reproducing layer on the reproducing light beam-incoming side is higher than the composition ratio of the transition metal at the surface on the side opposite to the reproducing light beam-incoming side, even when any difference in temperature arises between the surface of the reproducing layer on the reproducing light beam-incoming side and the surface on the side opposite thereto when the reproducing light beam is radiated. Therefore, the operation to expand the magnetic domain of the reproducing layer is smoothly performed when the magnetic domain of the reproducing layer, which is transferred from the recording layer during the reproduction, is expanded. Thus, the jitter of the reproduced signal is lowered, and S/N of the reproduced signal is improved.

What is claimed is:

1. A magneto-optical recording medium wherein a magnetic domain is expanded to reproduce information from the expanded magnetic domain by irradiating the magneto-optical recording medium with a reproducing light beam comprising:
a recording layer which is formed of a rare earth transition metal;
a reproducing layer which is formed of a rare earth transition metal; and
an auxiliary magnetic layer which is formed of a magnetic material and which is arranged between the recording layer and the reproducing layer,
wherein a transition metal, which is contained in the rare earth transition metal at a surface of the reproducing layer on a reproducing light beam-incoming side, has a composition ratio which is higher than a composition ratio of a transition metal which is contained in the rare earth transition metal at a surface of the reproducing layer on a side opposite to the reproducing light beam-incoming side.

2. The magneto-optical recording medium according to claim 1, wherein the composition ratio of the transition metal contained in the rare earth transition metal at the surface of the reproducing layer on the reproducing light beam-incoming side is higher by a range of 0.5 at. % to 4.5 at. % than the composition ratio of the transition metal contained in the rare earth transition metal at the surface of the reproducing layer on the side opposite to the reproducing light beam-incoming side.

3. The magneto-optical recording medium according to claim 1, wherein an increment amount of a composition ratio of the transition metal contained in the rare earth transition metal at an intermediate position in a thickness direction in the reproducing layer with respect to the composition ratio of the transition metal contained in the rare earth transition metal at the surface of the reproducing layer on the side opposite to the reproducing light beam-incoming side is not more than ¼ of an increment amount of the composition ratio of the transition metal contained in the rare earth transition metal at the surface of the reproducing layer on the reproducing light beam-incoming side with respect to the composition ratio of the transition metal contained in the rare earth transition metal at the surface of the reproducing layer on the side opposite to the reproducing light beam-incoming side.

4. The magneto-optical recording medium according to claim 1, wherein an increment amount of a composition ratio of the transition metal contained in the rare earth transition metal at an intermediate position in a thickness direction in the reproducing layer with respect to the composition ratio of the transition metal contained in the rare earth transition metal at the surface of the reproducing layer on the side opposite to the reproducing light beam-incoming side is not more than ⅛ of an increment amount of the composition ratio of the transition metal contained in the rare earth transition metal at the surface of the reproducing layer on the reproducing light beam-incoming side with respect to the composition ratio of the transition metal contained in the rare earth transition metal at the surface of the reproducing layer on the side opposite to the reproducing light beam-incoming side.

5. The magneto-optical recording medium according to claim 1, wherein the composition ratio of the transition metal contained in the rare earth transition metal which forms the reproducing layer is increased continuously at positions nearer to the surface of the reproducing layer on the reproducing light beam-incoming side in a thickness direction in the reproducing layer.

6. The magneto-optical recording medium according to claim 1, wherein the recording layer, the auxiliary magnetic layer, and the reproducing layer are subjected to magnetic exchange coupling in a state in which the magneto-optical recording medium is not irradiated with the reproducing light beam; the magnetic domain, which is transferred from the recording layer to the reproducing layer, is expanded to reproduce information from the expanded magnetic domain by irradiating the magneto-optical recording medium with the reproducing light beam to heat to a temperature not less than a temperature at which an exchange coupling force between the recording layer and the reproducing layer is cut off.

7. The magneto-optical recording medium according to claim 1, wherein the reproducing light beam is radiated onto the reproducing layer, the auxiliary magnetic layer, and the recording layer without passing through a substrate.

8. The magneto-optical recording medium according to claim 1, further comprising an enhancing layer which is formed of an SiN film and which is disposed on a surface of the reproducing layer on a side opposite the auxiliary magnetic layer.

9. A magneto-optical recording medium wherein a magnetic domain is expanded to reproduce information from the expanded magnetic domain by irradiating the magneto-optical recording medium with a reproducing light beam comprising:
a recording layer which is formed of a rare earth transition metal;
a reproducing layer which is formed of a rare earth transition metal; and
an auxiliary magnetic layer which is formed of a magnetic material and which is arranged between the recording layer and the reproducing layer,
wherein the reproducing layer is formed with a first reproducing layer and a second reproducing layer, the second reproducing layer is arranged on a reproducing light beam-incoming side as compared with the first reproducing layer, and a transition metal, which is contained in the rare earth transition metal which forms the second reproducing layer, has a composition ratio which is higher than a composition ratio of a transition metal which is contained in the rare earth transition metal which forms the first reproducing layer.

10. The magneto-optical recording medium according to claim 9, wherein the composition ratio of the transition metal contained in the rare earth transition metal which forms the second reproducing layer is higher by a range of 0.5 at. % to 4.5 at. % than the composition ratio of the transition metal contained in the rare earth transition metal which forms the first reproducing layer.

11. The magneto-optical recording medium according to claim 9, wherein the recording layer, the auxiliary magnetic layer, and the reproducing layer are subjected to magnetic exchange coupling in a state in which the magneto-optical recording medium is not irradiated with the reproducing light beam; the magnetic domain, which is transferred from the recording layer to the reproducing layer, is expanded to reproduce information from the expanded magnetic domain by irradiating the magneto-optical recording medium with the reproducing light beam to heat to a temperature not less than a temperature at which an exchange coupling force between the recording layer and the reproducing layer is cut off.

12. The magneto-optical recording medium according to claim 9, wherein the reproducing light beam is radiated onto the reproducing layer, the auxiliary magnetic layer, and the recording layer without passing through a substrate.

13. The magneto-optical recording medium according to claim 9, further comprising an enhancing layer which is formed of an SiN film and which is disposed on a surface of the reproducing layer on a side opposite the auxiliary magnetic layer.

14. A method for producing the magneto-optical recording medium as defined in claim 1, comprising the steps of forming the reproducing layer, the auxiliary magnetic layer, and the recording layer by performing sputtering with targets of transition metals and rare earth metals which form the reproducing layer, the auxiliary magnetic layer, and the recording layer, wherein an electric power, which is input to the target of the transition metal or the rare earth metal which forms the reproducing layer, is changed according to a sputtering time when the reproducing layer is formed by performing the sputtering.

15. A method for producing the magneto-optical recording medium as defined in claim 9, comprising the steps of forming the reproducing layer, the auxiliary magnetic layer, and the recording layer by performing sputtering with targets of transition metals and rare earth metals which form the reproducing layer, the auxiliary magnetic layer, and the recording layer, wherein an electric power, which is input to the target of the transition metal or the rare earth metal which forms the reproducing layer, is changed according to a sputtering time when the reproducing layer is formed by performing the sputtering.
